(19) United States
(12) Patent Application Publication
(10) Pub. No.: US 2026/0146725 A1
(43) Pub. Date: May 28, 2026

(54) LIGHTING APPARATUS FOR A MOTOR VEHICLE

(71) Applicant: HELLA GmbH & Co. KGaA, Lippstadt (DE)

(72) Inventors: Carsten HOHMANN, Warstein (DE); Marc KAUP, Paderborn (DE); Martin MUEGGE, Geseke (DE); Burkhard PEITZ, Paderborn (DE)

(73) Assignee: HELLA GmbH & Co. KGaA, Lippstadt (DE)

(21) Appl. No.: 19/403,548

(22) Filed: Nov. 28, 2025

(30) Foreign Application Priority Data
Nov. 27, 2024 (DE) 10 2024 134 994.8

(51) Int. Cl. F21S 43/241; F21S 43/31

(52) U.S. Cl. CPC F21S 43/241; F21S 43/31

(57) ABSTRACT

A lighting apparatus for a motor vehicle, comprising at least one light source. The lighting apparatus being configured in such a way that, in the state of the lighting apparatus installed in the motor vehicle, the light generated by the light source at least partially emerges from the lighting apparatus. The emerging light strikes a vehicle body surface of the motor vehicle or a reflection device arranged on a vehicle body surface of the motor vehicle. The light being at least partially reflected by the vehicle body surface or the reflection device such that it moves away from the motor vehicle. The lighting apparatus also comprises a light guide, which has an inlet surface for the light generated by the light source and an outlet surface for the light entering the light guide through the inlet surface.

This nonprovisional application claims priority under 35 U.S.C. § 119(a) to German Patent Application No. 102024134 994.8, which was filed in Germany on November 27, 2024, and which is herein incorporated by reference.

### BACKGROUND OF THE INVENTION

### Field of the Invention

The present invention relates to a lighting apparatus for a motor vehicle.

### Description of the Background Art

Typical tail lamps have up now been designed in such a way that they are made up of a housing and a cover panel, between which the inner components of the optical systems or design elements are arranged, which form a visible light signature, for example for a tail light or a brake light.

A lighting apparatus of the type mentioned at the outset is known from DE 102023108414 A1, which is incorporated herein by reference. The lighting apparatus described therein is designed as a lighting apparatus for the back region of a motor vehicle and comprises a light source, a housing, on or in which the light source is arranged, a cover panel, which covers the housing, at least in sections, as well as a reflection device, which is arranged outside the housing. The lighting apparatus is configured in such a way that, in the installed state of the lighting apparatus, the light generated by the light source emerges from the housing of the lighting apparatus at least partially through the cover panel, the light emerging through the cover panel at least partially strikes the reflection device and is at least partially reflected by the reflection device in such a way that it moves backwards away from the back region of the motor vehicle. The reflection device may be arranged on a surface of the vehicle body of the motor vehicle.

### SUMMARY OF THE INVENTION

It is therefore an object of the present invention to provide a lighting apparatus, which has a design deviating from that of the tail lamps described and which makes it possible to save components compared to the prior art, in particular, to design the lighting apparatus in a more sustainable manner despite a high stylistic requirement, by saving material.

According to an example of the invention, a lighting apparatus is provided that comprises a light guide, which has an inlet surface for the light generated by the light source and at least one outlet surface for the light that has entered the light guide through the inlet surface, in the state of the lighting apparatus installed in the motor vehicle, the light guide extending through an opening of the vehicle body of the motor vehicle, at least in sections, and protruding outwardly from the opening away from the vehicle body, the at least one outlet surface being arranged outside the vehicle body, so that the light emerging from the light guide directly reaches the outer region of the motor vehicle. On the one hand, an independent design is achieved by the direct emergence of the light from the outlet surface into the outer region of the motor vehicle and, on the other hand, material for an unnecessary covering or cover panel is saved.

It is possible that at least one outlet surface or one of the outlet surfaces is arranged on the side and/or on the front with respect to the direction of the extension of the light guide through the opening of the vehicle body, in particular, guide in the state of the lighting apparatus installed in the motor vehicle, the at least one outlet surface or one of the outlet surfaces being a lower surface of the light, from which the light emerges downwardly during the operation of the lighting apparatus. Due to this design, it is achieved that the light emerging downwardly from the light guide in the direction of the vehicle body surface or the reflection device is reflected to the back from a region below the light guide. This backwardly reflected light may implement, for example, the function of a tail light. The luminous area as a whole may be enlarged hereby, and a better ability to perceive the signal function, for example, of a tail light, a brake light, or a turn signal, may be achieved.

The design of the vehicle body surface influences the visibility of the backwardly reflected light. If the vehicle body surface is smooth, the angle between the vehicle body surface and the outlet surface is crucial for the visibility and the light reflection on the vehicle body surface. A broadly scattering light emission from the light guide is advantageous, so that light beams always fall onto the vehicle body surface at a suitable angle to be visibly reflected for an observer. It may furthermore be provided that the vehicle body surface is laminated, the film having a structure or texture which advantageously makes a diffuse light reflection available, It may also be provided that the paintwork of the vehicle body is implemented by a matte textured paint in this area, which advantageously makes a diffuse light reflection available. An additional component used as a reflection device may also be provided on the vehicle body surface, for example as a transparent panel having an optical structure. The transparent panel may also be equipped, for example, with a holographic film, the integrated hologram being designed as a reflection hologram for forming a light distribution. It is advantageous that a transparent, structured panel may be installed on any vehicle body having any provided color. Instead of a transparent panel, an opaque panel is also possible, which has a reflective and diffusely scattering surface.

It may be provided, for example, that the light guide has, in addition to the first lower outlet surface, a second outlet surface which may be arranged on the end of the light guide facing away from the vehicle body. A portion of the light moving through the light guide may therefore not emerge downwardly through the lower outlet surface, but instead it may emerge from the light guide directly toward the back. This rear outlet surface extends, in particular, horizontally and is provided with a narrow design. In addition to the effect of an ambient illumination of the vehicle body surface, a downwardly occurring illumination of the vehicle body through the first outlet surface may also be important for a homologation of the lighting technology. If minimum surface area sizes are legally required for light functions, which, however, may not be made available by the surface area—or a section area—of the rear outlet surface of the light guide, the additional luminous area on the vehicle body may be added to the luminous area of the back end of the light guide to complete the total of the minimum surface area.

The light guide can have a deflecting surface, which is configured to deflect the light moving through the light guide, in particular by means of total reflection, in the direction of the outlet surface, in particular to deflect it in the direction of the side, preferably lower, outlet surface. The deflecting surface may be arranged on the side of the light guide facing away from the outlet surface, in particular, the deflecting surface being arranged on the upper side of the light guide in the state of the lighting apparatus installed in the motor vehicle. The deflecting surface makes it possible to ensure that a large portion of the light moving through the light guide is deflected onto the outlet surface and is coupled out of the outlet surface to illuminate the vehicle body surface or the component on the vehicle body surface used as the reflection device.

The perpendicular on the deflecting surface can enclose an angle not equal to 0° with the vertical direction in the state of the lighting apparatus installed in the motor vehicle, in particular, the perpendicular on the deflecting surface enclosing an angle between 10° and 60°, preferably an angle between 20° and 50°, with the vertical direction. By selecting a suitable angle of the deflecting surface, the direction in which the light emerges from the outlet surface may be adapted to the inclination of the vehicle body surface to be illuminated.

The light guide can include at least one prism, in particular multiple prisms, which is arranged in the region of the deflecting surface or adjacent to the deflecting surface and contributes to the deflection of the light moving through the light guide in the direction of the outlet surface. Due to the at least one additional prism in the vicinity of the deflecting surface, the surface area contributing to the deflection of the light may be enlarged so that more light is deflected in the direction of the outlet surface.

It is also possible that a reflective film and/or a reflective housing part can be arranged on the outside of the deflecting surface for the purpose of reflecting the light emerging from the deflecting surface back into the light guide. The share of the light deflected onto the outlet surface is also increased by this measure.

It may be provided that, in the state of the lighting apparatus installed in the motor vehicle, the light guide can have an extension in the vehicle transverse direction which is greater than the extension of the light guide in the vehicle longitudinal direction, in particular, in the state of the lighting apparatus installed in the motor vehicle, the thickness of the section of the light guide extending through the opening of the vehicle body of the motor vehicle is smaller in the vertical direction than the extension of the light guide in the vehicle longitudinal direction. It may furthermore be provided that, in the state of the lighting apparatus installed in the motor vehicle, the thickness of the section of the light guide extending through the opening of the vehicle body of the motor vehicle is smaller in the vertical direction than the extension of the inlet surface of the light guide in the vertical direction. The light guide is thus comparatively flat and may extend over a large part of the vehicle width, for example essentially over the entire rear hatch.

The at least one light source can be designed as a light-emitting diode (LED). In particular, a plurality of light-emitting diodes arranged side by side over the extension of the light guide in the vehicle transverse direction may be provided.

The lighting apparatus can comprise a flat light module, which is arranged in front of the inlet surface of the light guide, the flat light module being configured to allow the light emerging from the at least one light source to strike the inlet surface of the light guide. The flat light module may have a planar light guide as well as at least one scattering film or panel arranged between the planar light guide of the flat light module and the inlet surface of the light guide, the flat light module, in particular, having a reflective film or panel, which is arranged on the side of the planar light guide of the flat light module facing away from the inlet surface of the light guide. A flat light module of this type may very efficiently illuminate the inlet surface of the light guide in a homogeneous manner.

Further, the lighting apparatus can comprise a reflector, which is configured to allow the light emerging from the at least one light source to strike the inlet surface of the light guide, in particular, the lighting apparatus comprising a scattering film or panel, which is arranged between the reflector and the inlet surface of the light guide. The inlet surface of the light guide may also be homogeneously illuminated by a design of this type.

The lighting apparatus can be configured to allow the light emerging from the at least one light source to strike the inlet surface of the light guide directly or to strike the inlet surface of the light guide after passing through at least one lens comprised by the lighting apparatus, preferably at least one Fresnel lens comprised by the lighting apparatus. The inlet surface of the light guide may also be homogeneously illuminated by a design of this type.

At least one surface, in particular the inlet surface and/or the outlet surface, of the light guide can be provided with a structuring, in particular with a light-deflecting optic, for example a cushion optic, or a cylinder optic, or a prism optic, or with a light-scattering structure, for example an etched structure or an eroded structure or a laser structure. Do to the structuring, a suitable light scattering of the light emerging from the outlet surface may be achieved, in particular, a broadly scattering light emission from the outlet surface may be achieved.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a section of an example of a lighting apparatus according to the invention in the state installed in a motor vehicle;

FIG. 2 shows a section of the lighting apparatus according to FIG. 1, different inclinations of the vehicle body surface arranged under the lighting apparatus being illustrated;

FIG. 3 shows a detailed view of the light guide of the lighting apparatus according to FIG. 1;

FIG. 4 shows a section of an example of a lighting apparatus according to the invention in the state installed in a motor vehicle, different inclinations of the vehicle body surface arranged under the lighting apparatus being illustrated;

FIG. 5 shows a section of an example of a lighting apparatus according to the invention in a state installed in a motor vehicle, different inclinations of the vehicle body surface arranged under the lighting apparatus being illustrated;

FIG. 6 shows a detailed view of the light guide of the lighting apparatus according to FIG. 5, including sketched light beams;

FIG. 7 shows a section of an example of a lighting apparatus according to the invention in a state installed in a motor vehicle, including sketched light beams, different inclinations of the vehicle body surface arranged under the lighting apparatus being illustrated;

FIG. 8 shows a section of an example of a lighting apparatus according to the invention in the state installed in a motor vehicle, including sketched light beams, different inclinations of the vehicle body surface arranged under the lighting apparatus being illustrated; and

FIG. 9 shows a rear view of a part of a back region of a motor vehicle, including an example of a lighting apparatus according to the invention.

### DETAILED DESCRIPTION

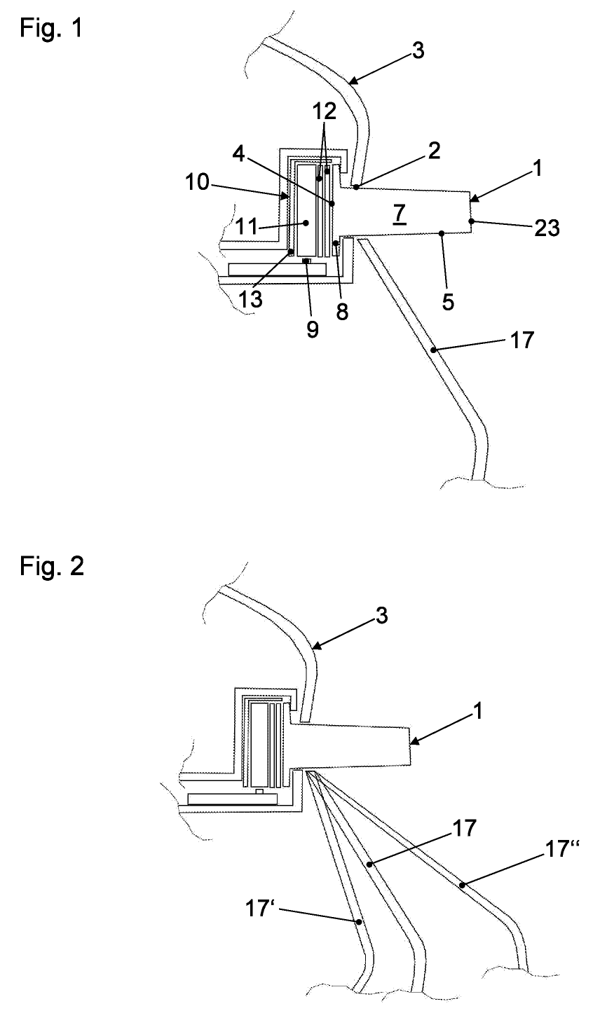

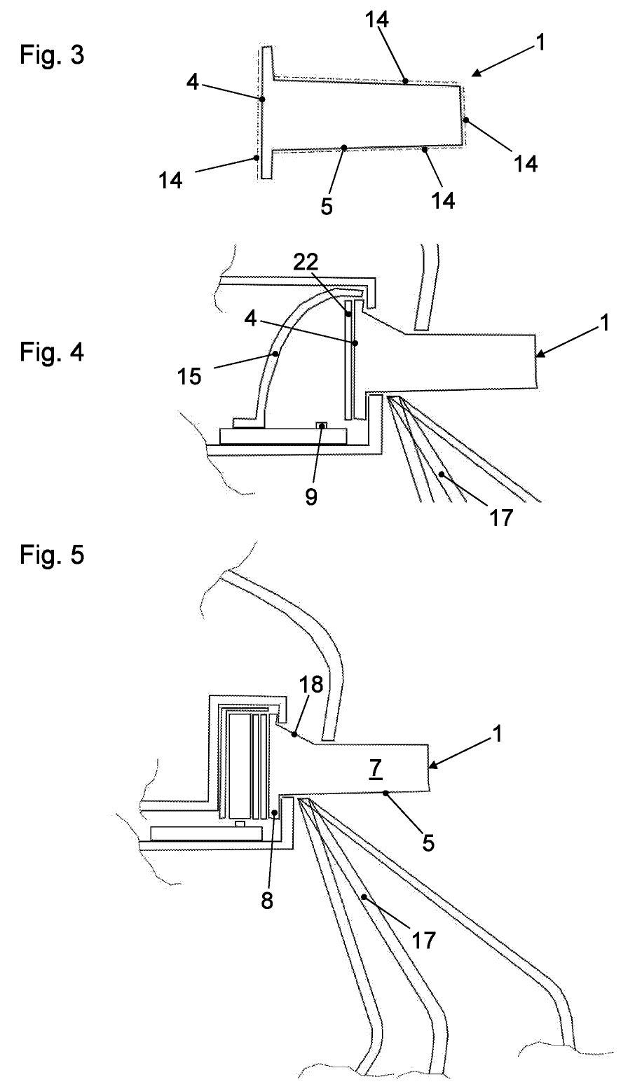

The lighting apparatus illustrated in the figures comprises a light guide 1, which, in the state of the lighting apparatus installed in the motor vehicle, extends through an opening 2 of the vehicle body 3 of the motor vehicle and protrudes from opening 2 outwardly away from vehicle body 2 (cf. FIG. 1). Light guide 1 has an inlet surface 4 arranged in the interior of the motor vehicle or within vehicle body 3 and an outlet surface 5 for light arranged outside vehicle body 3. In the figures, outlet surface 5 is arranged on the underside of light guide 1.

It is entirely possible that outlet surface 5 is arranged on a different side surface of light guide 1, for example on the upper side of light guide 1. In addition to outlet surface 5 arranged on a side surface, a second outlet surface may also be provided on narrow end face 23 of light guide 1, which is arranged on the side of light guide 1 facing away from vehicle body 3 in the installed state.

In the examples, light guide 1 protrudes outwardly from opening 2 in the vehicle longitudinal direction away from vehicle body 3. However, it is entirely possible that light guide 1 protrudes outwardly from opening 2 away from vehicle body 3 vertically or at an angle. The direction in which light guide 1 protrudes away from vehicle body 3 is dependent on the design or styling of the motor vehicle and the design or styling of the lighting apparatus.

Light guide 1 is comparatively flat and may extend over a large part of the vehicle width, for example essentially over entire rear hatch 6 (cf. FIG. 9). In particular, the extension of light guide 1 is therefore greater in the vehicle transverse direction than the extension of light guide 1 in the vehicle longitudinal direction. In the state of the lighting apparatus installed in the motor vehicle, the vertical thickness of section 7 of light guide 1 extending through opening 2 of vehicle body 3 of the motor vehicle is also smaller than the extension of the light guide in the vehicle longitudinal direction (cf. FIG. 1). Inlet surface 4 arranged in the interior of vehicle body 3 is arranged on a thickened section 8 of light guide 1 which, in the vertical direction, is approximately twice the thickness of section 7 of light guide 1 extending through opening 2 of vehicle body 3 of the motor vehicle.

Section 7 of light guide 1 extending through opening 2 of vehicle body 3 of the motor vehicle tapers in the vertical direction, starting from thickened section 8. It is alternatively entirely possible that section 7 of light guide 1 extending through opening 2 of vehicle body 3 of the motor vehicle has a constant thickness over its longitudinal extension in the vehicle longitudinal direction.

The lighting apparatus comprises at least one light source 9, which is designed as a light-emitting diode (LED). In particular, multiple light sources 9 designed as light-emitting diodes are provided, which are arranged side by side in the vehicle transverse direction or in the direction extending in the plane of the drawing in FIG. 1.

A so-called flat light module 10 is provided between light sources 9 and inlet surface 4 of light guide 1. This flat light module 10 has a planar light guide 11, into which the light emerging from light sources 9 is coupled from below. The light entering planar light guide 11 of flat light module 10 leaves planar light guide 11 to the right in FIG. 1 in the direction of inlet surface 4 of light guide 1 extending through opening 2 of vehicle body 3. Two scattering films 12 or panels are arranged between planar light guide 11 and inlet surface 4, which are part of flat light module 10. Due to these scattering films 12 or panels, a homogeneous illumination of inlet surface 4 of light guide 1 extending through vehicle body 3 is achieved. A reflective film 13 or panel, which is also part of flat light module 10, is arranged on the left side in FIG. 1 or the back side of planar light guide 11 of flat light module 10. This reflective film 13 or panel is used to couple light emerging from planar light guide 11 to the left in FIG. 1 back into light guide 11, by which means the effectiveness of the illumination of inlet surface 4 of light guide 1 extending through vehicle body 3 is increased.

Light guide 1 may be provided with a structuring 14 on its inlet surface 4 as well as on its outlet surface 5 or an another of its outer surfaces. Structuring 14 may have an light-deflecting optic, for example a cushion optic or a cylinder optic, or a prism optic. Alternatively, structuring 14 may have a light-scattering structure, for example an etched structure, or an eroded structure, or a laser structure. Due to the structuring, a suitable light scattering of the light emerging from outlet surface 5 may be achieved, in particular, a broadly scattering light emission from outlet surface 5 being able to be achieved.

The example of the lighting apparatus illustrated in FIG. 4 has a reflector 15 instead of flat light module 10. The lighting apparatus comprises a scattering film 22 or panel, which is arranged between reflector 15 and inlet surface 4 of light guide 1. The light emerging from the at least one light source 9 is reflected by reflector 15 onto inlet surface 4 through scattering film 22 or panel.

It is alternatively possible that, instead of flat light module 10 and instead of reflector 15, the lighting apparatus is designed in such a way that the light emerging from the at least one light source 9 may spread out comparatively directly in the direction of inlet surface 4 of light guide 1. At least one lens, in particular at least one Fresnel lens, may be provided between the at least one light source 9 and inlet surface 4 of light guide 1 to achieve a comparatively direct illumination of inlet surface 4.

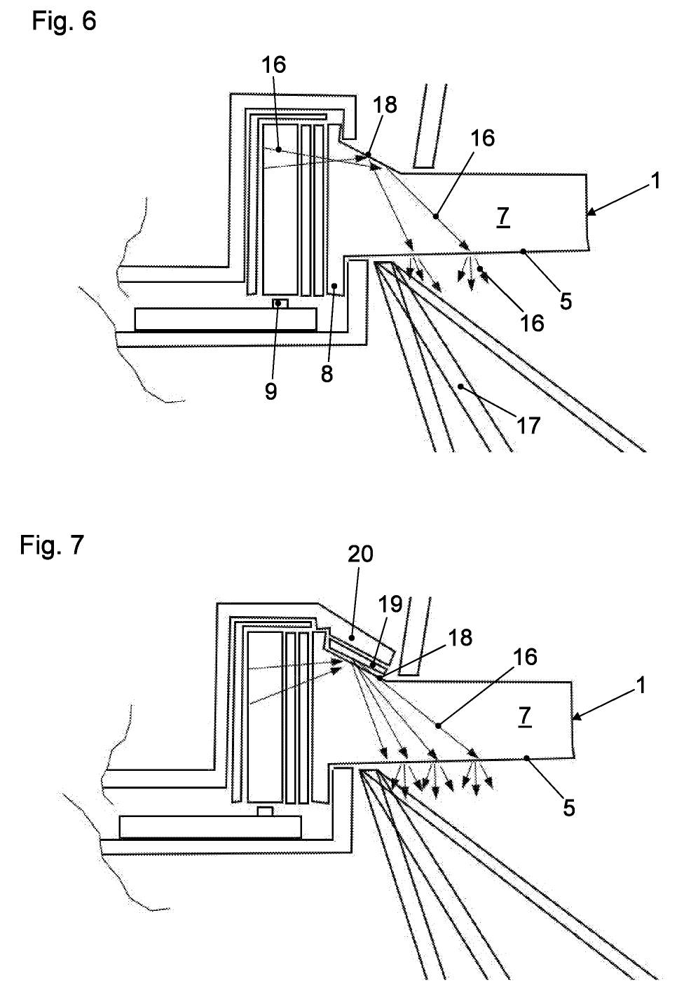

The lighting apparatus is configured in such a way that, in the state of the lighting apparatus installed in the motor vehicle, light 16 generated by light source 9 at least partially enters inlet surface 4 of light guide 1, and light 16 entering light guide 1 through inlet surface 4 at least partially exits outlet surface 5. The lighting apparatus is configured in such a way that light 16 emerging from outlet surface 5 strikes a vehicle body surface 17 of the motor vehicle and is at least partially reflected by vehicle body surface 17 of the vehicle body in such a way that it moves away from the motor vehicle, in particular, it moves away to the back of the motor vehicle (cf. FIG. 1, FIG. 6, and FIG. 9). This backwardly reflected light may implement, for example, the function of a tail light.

The design of vehicle body surface 17 influences the visibility of backwardly reflected light 16. If vehicle body surface 17 is smooth, the angle between the vehicle body surface and outlet surface 5 is crucial for the visibility and the light reflection on vehicle body surface 17. Three different vehicle body surfaces 17, 17’,17” are therefore drawn in FIG. 2 and FIGS. 4 through FIG. 8, which differ in terms of their different inclinations relative to outlet surface 5.

A broadly scattering light emission from light guide 1 is advantageous, so that light beams always fall onto vehicle body surface 17, 17’, 17” at a suitable angle to be visibly reflected for an observer. It may furthermore be provided that vehicle body surface 17, 17’, 17” is laminated, the film having a structure or texture which advantageously makes a diffuse light reflection available. It may also be provided that the paintwork of the vehicle body is implemented by a matte textured paint in this area, which advantageously makes a diffuse light reflection available. An additional component, which can be used as a reflection device, may also be provided on the vehicle body surface 17, 17’, 17”, for example as a transparent panel having an optical structure. It is advantageous that a transparent, structured panel of this type may be installed on any vehicle body having any provided color. Instead of a transparent panel, an opaque panel is also possible, which has a reflective and diffusely scattering surface.

The example according to FIG. 5 and FIG. 6 differs from the example according to FIG. 1 in that light guide 1 has a deflecting surface 18, which deflects light 16 moving through light guide 1 in the direction of outlet surface 5 by means of total reflection. Deflecting surface 18 is arranged on the side of light guide 1 facing away from outlet surface 5 or on the upper side of light guide 1 in the state of the lighting apparatus installed in the motor vehicle.

Deflecting surface 18 is suitably inclined, the perpendicular on the deflecting surface enclosing an angle between 20° and 50° with the vertical direction in the state of the lighting apparatus installed in the motor vehicle. Deflecting surface 18 begins at the end of thickened section 8 of light guide 1 and extends a short distance through opening 2 of the vehicle body. Deflecting surface 18 is formed on section 7 extending through opening 2 of vehicle body 3 of the motor vehicle. The extension of section 7 extending through opening 2 of vehicle body 3 of the motor vehicle in the vehicle longitudinal direction is approximately three times to four times the size of the extension of deflecting surface 18 in the vehicle longitudinal direction.

The example according to FIG. 7 differs from the example according to FIG. 6 in that a reflective film 19 and a reflective housing part 20 are arranged on the outside of deflecting surface 18 for the purpose of reflecting light emerging from deflecting surface 18 back into light guide 1. It may be provided to provide only a reflective film 19 or only a reflective housing part 20.

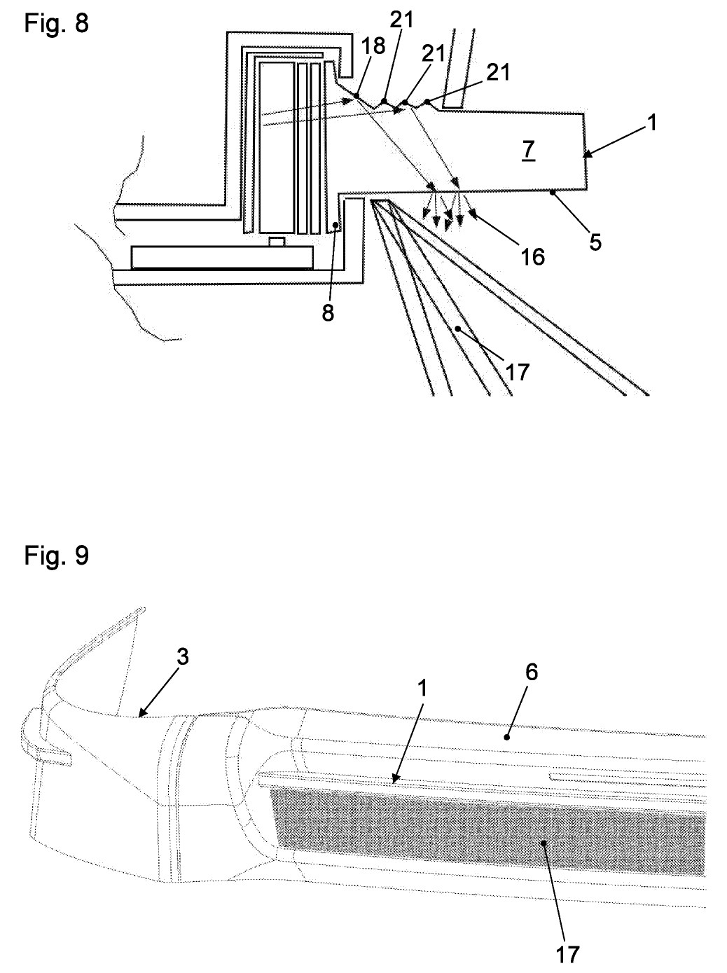

The example according to FIG. 8 differs from the example according to FIG. 6 in that light guide 1 includes multiple strip-shaped prisms 21 extending over the extension of light guide 1 in the vehicle transverse direction. Prisms 21 are adjacent to each other in the vehicle longitudinal direction, the first of prisms 21 abutting deflecting surface 18. Due to the plurality of prisms 21 in the vicinity of deflecting surface 18, the surface contributing to the deflection of light 16 may be enlarged so that more light 16 is deflected in the direction of outlet surface 5.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A lighting apparatus for a motor vehicle, the lighting apparatus comprising:
at least one light source; and
a light guide having an inlet surface for light generated by the light source and at least one outlet surface for light entering the light guide through the inlet surface,
wherein the lighting apparatus is configured such that, in the state of the lighting apparatus installed in the motor vehicle, the light generated by the light source at least partially emerges from the lighting apparatus, the emerging light strikes a vehicle body surface of the motor vehicle or a reflection device arranged on a vehicle body surface of the motor vehicle, and the light is at least partially reflected by the vehicle body surface or the reflection device such that it moves away from the motor vehicle, and
wherein, in the state of the lighting apparatus installed in the motor vehicle, the light guide extends through an opening of the vehicle body of the motor vehicle, at least in sections, and projects from the opening outwardly away from the vehicle body, the at least one outlet surface being arranged outside the vehicle body so that the light emerging from the light guide directly reaches the outer region of the motor vehicle.

2. The lighting apparatus according to claim 1, wherein the at least one outlet surface or one of the outlet surfaces is arranged on a side and/or on a front with respect to the direction of the extension of the light guide through the opening of the vehicle body, or wherein, in the state of the lighting apparatus installed in the motor vehicle, the at least one outlet surface or one of the outlet surfaces is a lower surface of the light guide from which the light emerges downwardly during the operation of the lighting apparatus.

3. The lighting apparatus according to claim 1, wherein the light guide has a deflecting surface, which is configured to deflect the light moving through the light guide via total reflection, in a direction of the outlet surface to deflect it in a direction of the side or a lower, outlet surface.

4. The lighting apparatus according to claim 3, wherein the deflecting surface is arranged on the side of the light guide facing away from the outlet surface, or wherein the deflecting surface is arranged on an upper side of the light guide in the state of the lighting apparatus installed in the motor vehicle.

5. The lighting apparatus according to claim 3, wherein the perpendicular on the deflecting surface encloses an angle not equal to 0° with the vertical direction in the state of the lighting apparatus installed in the motor vehicle, or wherein the perpendicular on the deflecting surface encloses an angle between 10° and 60° or an angle between 20° and 50°, with the vertical direction.

6. The lighting apparatus according to claim 3, wherein the light guide includes at least one prism, in particular multiple prisms, which is arranged in the region of the deflecting surface or adjacent to the deflecting surface and contributes to the deflection of the light moving through the light guide in the direction of the outlet surface.

7. The lighting apparatus according to claim 3, wherein a reflective film and/or a reflective housing part is/are arranged on the outside of the deflecting surface for the purpose of reflecting the light emerging from the deflecting surface back into the light guide.

8. The lighting apparatus according to claim 1, wherein, in the state of the lighting apparatus installed in the motor vehicle, the light guide has an extension in the vehicle transverse direction which is greater than the extension of the light guide in the vehicle longitudinal direction, or wherein, in the state of the lighting apparatus installed in the motor vehicle, a thickness of the section of the light guide extending through the opening of the vehicle body of the motor vehicle is smaller in the vertical direction than the extension of the light guide in the vehicle longitudinal direction.

9. The lighting apparatus according to claim 1, wherein, in the state of the lighting apparatus installed in the motor vehicle, a thickness of the section of the light guide extending through the opening of the vehicle body of the motor vehicle is smaller in the vertical direction than the extension of the inlet surface of the light guide in the vertical direction.

10. The lighting apparatus according to claim 1, wherein the at least one light source is designed as a light-emitting diode.

11. The lighting apparatus according to claim 1, wherein the lighting apparatus comprises a flat light module, which is arranged in front of the inlet surface of the light guide, the flat light module being configured to allow the light emerging from the at least one light source to strike the inlet surface of the light guide.

12. The lighting apparatus according to claim 11, wherein the flat light module has a planar light guide as well as at least one scattering film or panel arranged between the planar light guide of the flat light module and the inlet surface of the light guide, or wherein, the flat light module also has a reflective film or panel, which is arranged on the side of the planar light guide of the flat light module facing away from the inlet surface of the light guide.

13. The lighting apparatus according to claim 1, wherein the lighting apparatus comprises a reflector, which is configured to allow the light emerging from the at least one light source to strike the inlet surface of the light guide, or wherein, the lighting apparatus comprises a scattering film or panel, which is arranged between the reflector and the inlet surface of the light guide.

14. The lighting apparatus according to claim 1, wherein the lighting apparatus is configured to allow the light emerging from the at least one light source to strike the inlet surface of the light guide directly or to strike the inlet surface of the light guide after passing through at least one lens comprised by the lighting apparatus or at least one Fresnel lens comprised by the lighting apparatus.

15. The lighting apparatus according to claim 1, wherein at least one surface or an inlet surface and/or an outlet surface of the light guide is provided with a structuring with a light-deflecting optic, a cushion optic, a cylinder optic, or a prism optic, or is provided with a light-scattering structure, an etched structure, an eroded structure, or a laser structure.
